(19) United States
(12) Patent Application Publication
(10) Pub. No.: US 2013/0248636 A1
(43) Pub. Date: Sep. 26, 2013

(54) WINDING DEVICE AND WINDING METHOD

(71) Applicant: KABUSHIKI KAISHA TOSHIBA, Minato-ku (JP)

(72) Inventors: Masaomi Nakahata, Kamakura-shi (JP); Fujio Takahashi, Kashiwazaki-shi (JP)

(73) Assignee: KABUSHIKI KAISHA TOSHIBA, Minato-ku (JP)

(21) Appl. No.: 13/842,181

(22) Filed: Mar. 15, 2013

(30) Foreign Application Priority Data
Mar. 22, 2012 (JP) 2012-066275

(51) Int. Cl. H01F 41/06

(52) U.S. Cl. CPC H01F 41/0641
USPC 242/437.3

(57) ABSTRACT

According to one embodiment, a winding device includes, a winding core having a non precise circle cross-section perpendicular to a direction in which a center of rotation extends, and a holding device including a first holding section and a second holding section configured to hold the windable material therebetween such that an imaginary line which passes between the first and second holding sections and extends perpendicular to a direction in which the windable material is introduced between the first and second holding sections and the extending direction of the center of rotation passes through a position off the center of rotation and that at least part of the winding core overlaps the imaginary line while the winding core is rotating.

### CROSS-REFERENCE TO RELATED APPLICATIONS

This application is based upon and claims the benefit of priority from Japanese Patent Application No. 2012-066275, filed Mar. 22, 2012, the entire contents of which are incorporated herein by reference.

### FIELD

Embodiments described herein relate generally to a winding device and a winding method for winding a windable material, such as an electrode of a battery, around a winding core.

### BACKGROUND

Conventionally, a lithium-ion battery comprises a coiled electrode assembly. There is a method in which a coiled electrode assembly is formed by winding positive and negative electrodes, with a separator therebetween, around a flat winding core. An integral structure comprising these electrodes and separator is wound around the winding core by rotating the winding core.

The winding core is designed to have a hexagonal cross-section, which keeps the integral structure comprising the positive and negative electrodes and separator from flapping as it is wound around the winding core.

### BRIEF DESCRIPTION OF THE DRAWINGS

FIG. 1 is a schematic view showing a winding device according to a first embodiment;

FIG. 2 is a side view showing a holding device of the winding device;

FIG. 3 is an enlarged view of first and second rollers of the holding device;

FIG. 4 is a schematic view of the winding device in which first and second sections of a winding core are spaced apart from each other;

FIG. 5 is an enlarged view showing the first and second rollers and their surroundings in one state where the winding core does not overlap an imaginary line, out of states where the winding core is rotating so that an electrode plate is wound around it;

FIG. 6 is an enlarged view showing the first and second rollers and their surroundings in one state where the winding core overlaps the imaginary line, out of the states where the winding core is rotating so that the electrode plate is wound around it;

FIG. 7 is a schematic view of the winding device showing a state before the electrode plate is secured to the winding core;

FIG. 8 is a schematic view of the winding device showing a state where the electrode plate is secured between the first and second sections of the winding core and the first and second sections are connected to each other so that an end face is elliptical;

FIG. 9 is an enlarged view showing first and second pressing sections of a winding device according to a second embodiment;

FIG. 10 is a schematic view showing a winding device according to a third embodiment;

FIG. 11 is a schematic view showing a winding device according to a fourth embodiment; and

FIG. 12 is a schematic view showing a winding device according to a fifth embodiment.

### DETAILED DESCRIPTION

In general, according to one embodiment, a winding device includes a winding core, configured to rotate so that a windable material is wound therearound and having a non precise circle cross-section perpendicular to a direction in which a center of rotation extends, and a holding device located upstream relative to the winding core in a moving direction of the windable material and configured to hold the windable material therein, the holding device comprising a first holding section and a second holding section configured to hold the windable material therebetween such that an imaginary line which passes between the first and second holding sections and extends perpendicular to a direction in which the windable material is introduced between the first and second holding sections and the extending direction of the center of rotation passes through a position off the center of rotation and that at least part of the winding core overlaps the imaginary line while the winding core is rotating.

In general, according to one embodiment, a winding method includes locating relative positions of a winding core and a holding device, which is located upstream relative to the winding core in a moving direction of a windable material and comprising first and second holding sections, such that an imaginary line which passes between the first and second holding sections and extends perpendicular to a direction in which the windable material is introduced between the first and second holding sections and the extending direction of a center of rotation of the winding core passes through a fixing device disposed in the winding core and configured to secure the windable material to the winding core, passing the windable material between the first and second holding sections, securing the windable material passed between the first and second holding sections to the fixing device of the winding core, locating the relative positions of the winding core and the holding device so that the imaginary line passes through a position off the center of rotation of the winding core and that at least part of the winding core overlaps the imaginary line while the winding core is rotating, and winding the windable material around the winding core by rotating the winding core.

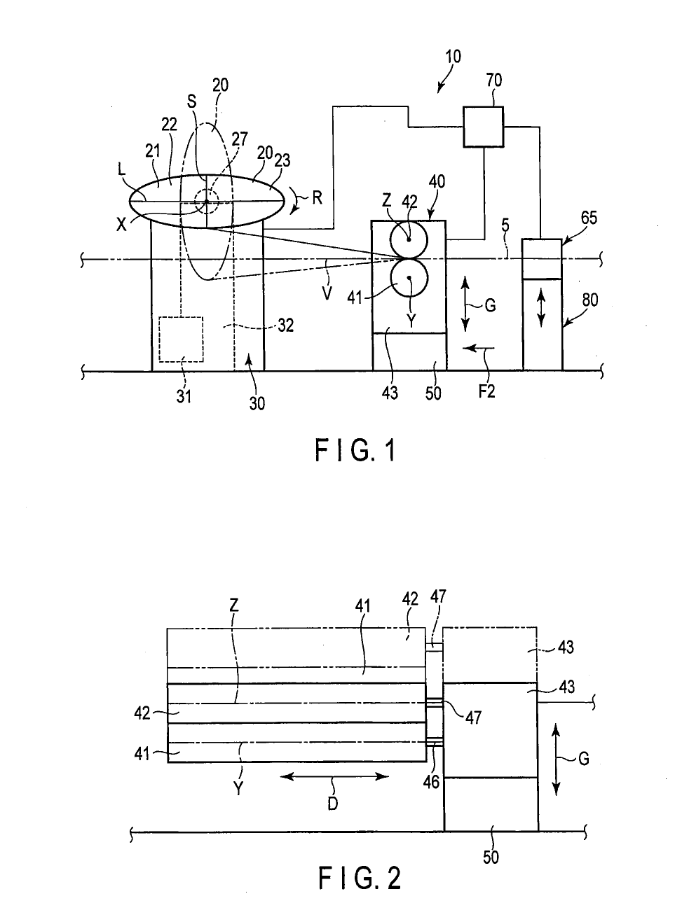

A winding device and a winding method according to a first embodiment will be described with reference to FIGS. 1 to 8. FIG. 1 is a schematic view showing a winding device 10. As shown in FIG. 1, the winding device 10 comprises a winding core 20, core drive device 30, holding device 40, holding-device position adjustment device 50, feeding device 65, control device 70, and feeding-device position adjustment device 80. The winding device 10 winds an electrode plate 5, as an example of a windable material, around the winding core 20. The electrode plate 5 comprises a positive-electrode sheet, negative-electrode sheet, and separator sandwiched between the positive- and negative-electrode sheets.

The winding core 20 is rotatably supported on the core drive device 30 (described later) by a rotating shaft 27. An end face 21 of the winding core 20 is shown in FIG. 1. Rotating shaft 27, which is located on the opposite side to the end face 21, is indicated by a dotted line in FIG. 1. The end face 21 has an elliptical shape. The elliptical shape is an example of a non precise circle shape. The non precise circle shape is assumed to be different from the shape of a perfect circle. The perfect circle is a circle having a constant radius. A cross-sectional shape of the winding core 20 perpendicular to a direction D in which an axis X of rotating shaft 27 of the winding core 20 extends is the same as that of the end face 21 shown in FIG. 1. Axis X is the center of rotating shaft 27, that is, the center of rotation of the winding core 20.

The winding core 20 has a predetermined length in the extending direction of axis X. Here, the predetermined length is greater than or equal to a length required to wind up the electrode plate 5. The structure of the winding core 20 will be specifically described later.

The core drive device 30 comprises for example an electric motor 31, for use as a drive source, and a connection mechanism 32 that connects the shaft of the electric motor 31 to rotating shaft 27 of the winding core 20. The connection mechanism 32 comprises, for example, a plurality of gears and the like, and serves to transmit the rotation of the shaft of the electric motor 31 to rotating shaft 27 of the winding core 20. The connection mechanism 32 may be, for example, a speed reducer.

The electric motor 31 and connection mechanism 32 are indicated by dotted lines in FIG. 1. As the motor 31 is driven, the rotation of its shaft is transmitted to rotating shaft 27 of the winding core 20 through the connection mechanism 32. Thereupon, the winding core 20 rotates about axis X. In FIG. 1, the winding core 20 rotated through a predetermined angle relative to the full-line image is indicated by a two-dot chain line.

The holding device 40 comprises first and second rollers 41 and 42 and support block 43. The first roller 41 is an example of a first holding section. The second roller 42 is an example of a second holding section. FIG. 2 is a view of the holding device 40 taken from a direction F2 in FIG. 1. FIG. 2 is a side view of the holding device 40. As shown in FIG. 2, the first and second rollers 41 and 42 are rotatably supported by the support block 43. As an example of a support structure, the support block 43 rotatably supports a rotating shaft 46 of the first roller 41. A rotating shaft 47 of the second roller 42 is rotatably supported by the support block 43. Alternatively, the first and second rollers 41 and 42 may be supported for rotation about rotating shafts 46 and 47 that are secured to the support block 43.

Each of the first and second rollers 41 and 42 has a circular shape in a direction perpendicular to axes Y and Z. The rollers 41 and 42 are equal in diameter.

The respective axes Y and Z of rotating shafts 46 and 47 of the first and second rollers 41 and 42 extend parallel to axis X of the winding core 20. The axes Y and Z are the respective centers of rotating shafts 46 and 47, that is, the respective centers of rotation of the rollers 41 and 42. The extending direction D of the axes X, Y and Z is a linear direction.

In the present embodiment, as shown in FIG. 1, the first and second rollers 41 and 42 are located so that axis Y of rotating shaft 46 of the first roller 41 overlaps axis Z of rotating shaft 47 of the second roller 42 in a vertical direction G. According to the present embodiment, the vertical direction G is parallel to the direction of gravitational action, which is downward. The second roller 42 is located above the first roller 41. The extending direction D is perpendicular to the vertical direction G.

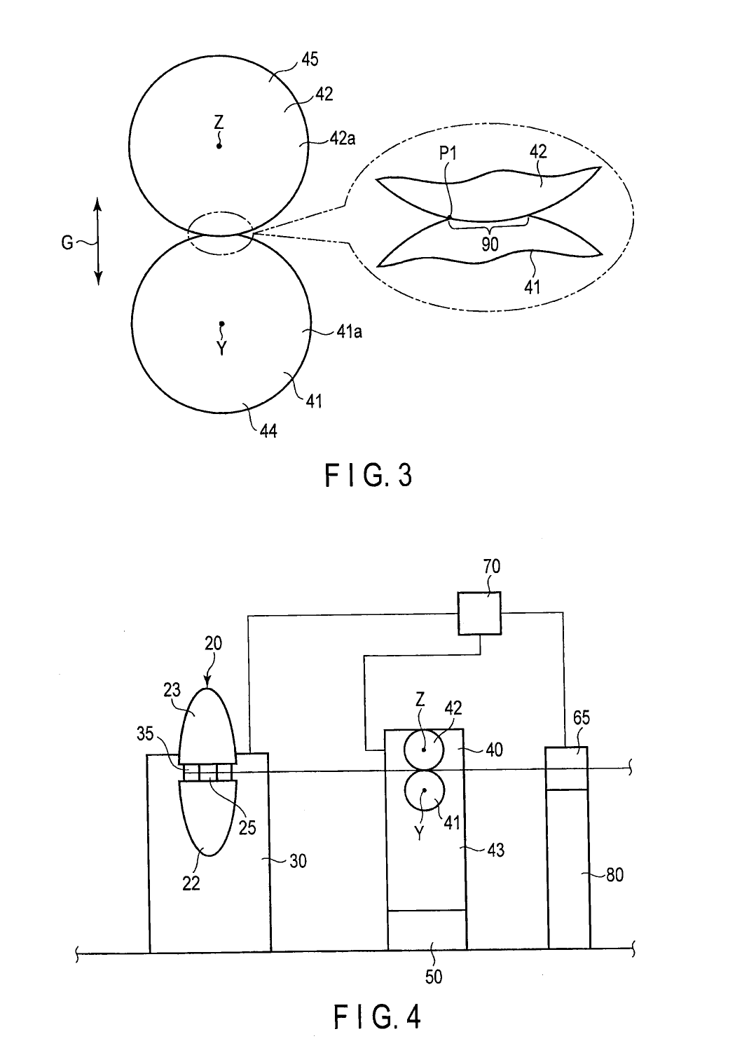

As shown in FIG. 1, the electrode plate 5 is held between the first and second rollers 41 and 42. FIG. 3 is an enlarged view showing respective end faces 44 and 45 of the rollers 41 and 42 between which the electrode plate 5 is not held. When the electrode plate 5 is not held between the rollers 41 and 42, as shown in FIG. 3, the rollers 41 and 42 are supported on the support block 43 in such a manner that they are pressed against each other in the vertical direction G. Thus, the first and second rollers 41 and 42 contact each other in the vertical direction G when the electrode plate 5 is not held between them.

An outer peripheral portion 41a of the first roller 41 is made of a material softer than that of an outer peripheral portion 42a of the second roller 42. In the present embodiment, the first and second rollers 41 and 42 are made of, for example, rubber and metal, respectively.

Thus, the outer peripheral portion 41a of the first roller 41 that is pressed against the second roller 42 is elastically deformed and dented along the outer peripheral portion 42a of the second roller 42. In FIG. 3, contact portions of the first and second rollers 41 and 42 are shown in an enlarged scale. That part of the outer peripheral portion 41a which is released from the contact with the outer peripheral portion 42a of the second roller 42 is elastically restored from the dented state as the first roller 41 rotates. The elastic deformation of the first roller 41 is exaggeratedly shown in FIG. 3. In fact, the amount of elastic deformation of the first roller 41 is small.

The following is a description of the materials of the outer peripheral portions 41a and 42a of the first and second rollers 41 and 42.

The outer peripheral portion 41a of the first roller 41 is made of, for example, urethane rubber and its Shore hardness should only be A40 or more. For example, the entire first roller 41 may be made of urethane rubber with the Shore hardness of A40 or more.

For example, aluminum and hard anodized aluminum are used for the outer peripheral portion 42a of the second roller 42. The outer peripheral portion 42a of the second roller 42 is practicable only if it is as hard as iron, aluminum, or stainless steel. Aluminum is preferred because of its adaptation to low inertia. To improve its longevity, however, the aluminum is anodized. Alternatively, the entire second roller 42 may be made of aluminum and hard anodized aluminum.

The holding device 40 holds the electrode plate 5 between the first and second rollers 41 and 42. As described previously, the electrode plate 5 is formed by laminating the positive- and negative-electrode sheets and separator. Further, the first and second rollers 41 and 42 contact each other and are freely rotatable. Accordingly, the electrode plate 5 is held between and pressed by the first and second rollers 41 and 42 as it passes between the rollers 41 and 42 from one side to the other. Thereupon, the sheet members that constitute the electrode plate 5 are brought into close contact with one another.

After having passed between the first and second rollers 41 and 42 from the one side to the other, the electrode plate 5 is secured to the winding core 20. In other words, the holding device 40 is located upstream relative to the winding core 20 in the moving direction of the electrode plate 5.

As shown in FIG. 2, the holding-device position adjustment device 50 is located below the support block 43. The holding-device position adjustment device 50 is an example of a position adjustment device. The position adjustment device 50 serves to move the support block 43 in the vertical direction G, thereby adjusting its position in the vertical direction G. The position adjustment device 50 may be, for example, a motor-driven type or comprise a pneumatic actuator. As the position of the support block 43 is changed by the position adjustment device 50, the positions of the first and second rollers 41 and 42 in the vertical direction G change.

The following is a specific description of the structure of the winding core 20. The winding core 20 comprises first and second sections 22 and 23. The first section 22 is one half of the winding core 20 divided along a minor axis S of the end face 21, and the second section 23 is the other half.

The core drive device 30 comprises a fixing mechanism 35, which connects the first and second sections 22 and 23 to each other and fixes them so that the end face 21 is elliptical. Further, the fixing mechanism 35 has the function of fixing the first and second sections 22 and 23 in such a manner that the two sections are spaced apart from each other along a major axis L. FIG. 4 shows the first and second sections 22 and 23 in a spaced state. The fixing mechanism 35 is shown in FIG. 4.

Further, a chuck mechanism 25 for fixing the electrode plate 5 is disposed between the first and second sections 22 and 23 of the winding core 20. The chuck mechanism 25 is an example of a fixing device. When the first and second sections 22 and 23 are connected to each other so that the end face 21 is elliptical, the chuck mechanism 25 is accommodated between the first and second sections 22 and 23. Therefore, in this state, the electrode plate 5 is held between the first and second sections 22 and 23.

The following is a specific description of correlations between the positions of the winding core 20 and holding device 40. The correlation in a driving state where the winding core 20 rotates so that the electrode plate 5 is wound around it will be described first. FIG. 1 shows the state wherein the winding core 20 rotates thereby the electrode plate 5 is wound around the winding core 20. As shown in FIG. 1, the correlation between the positions of the winding core 20 and holding device 40 in the driving state satisfies the following two conditions.

Condition 1: An imaginary line V that passes between the first and second rollers 41 and 42 and extends perpendicular to the direction in which the electrode plate 5 is introduced between the rollers 41 and 42 and the extending direction D of axis X of the winding core 20 passes through a position off axis X coincident with the center of rotation of the winding core 20. In the present embodiment, the direction in which the electrode plate 5 is introduced between the first and second rollers 41 and 42 is coincident with the extending direction of a line that connects the axes Y and X of the rollers 41 and 42, that is, the vertical direction G. Thus, according to the present embodiment, the imaginary line V is a straight line perpendicular to the vertical direction G and extending direction D. The imaginary line V is indicated by a two-dot chain line in FIG. 2.

Here, the position between the first and second rollers 41 and 42 through which the imaginary line V passes is a leading end position P1 in the moving direction of the electrode plate 5, within a range 90 where the rollers 41 and 42 contact each other without the electrode plate 5 between them. The contact range 90 and leading end position P1 are shown in FIG. 3.

Condition 2: While the winding core 20 is rotating about axis X so that the electrode plate 5 is wound around it, at least part of the winding core 20 overlaps the imaginary line V.

To satisfy Condition 1, according to the present embodiment, the winding core 20 is located in a position where the minor axis S does not overlap the imaginary line V. To satisfy Condition 2, an end portion of the winding core 20 overlaps the imaginary line V just before and after the major axis L of the end face 21 of the winding core 20 becomes perpendicular to the imaginary line V.

FIG. 5 shows the first and second rollers 41 and 42 and their surroundings in one state where the winding core 20 does not overlap the imaginary line V, out of states where the winding core 20 shown in FIG. 1 is rotating in a rotation direction R so that the electrode plate 5 is wound around it. When the winding core 20 does not overlap the imaginary line V, as shown in FIG. 5, that part of the electrode plate 5 which has passed between the rollers 41 and 42 is pulled to that side of the imaginary line V where the winding core 20 is located. Accordingly, an angle a defined by that part of the electrode plate 5 which has not yet passed between the rollers 41 and 42 and that part which has passed through there is an obtuse angle.

Thus, the part of the electrode plate 5 having passed between the first and second rollers 41 and 42 is slightly wound around that one of the rollers 41 and 42 which is located on that side of the imaginary line V where the winding core 20 is located. In the present embodiment, the roller which is located on that side of the imaginary line V where the winding core 20 is located is the second roller 42.

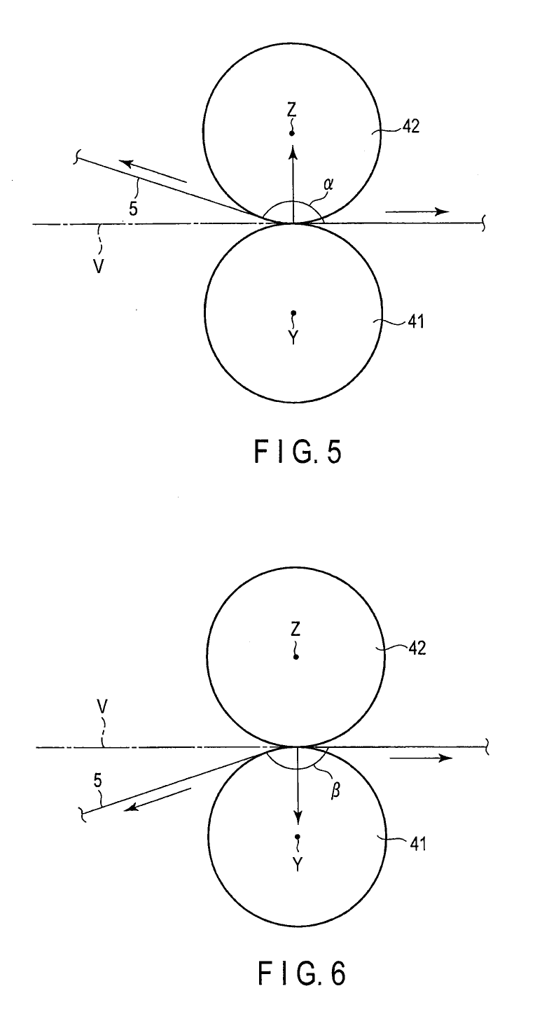

FIG. 6 shows the first and second rollers 41 and 42 and their surroundings in one state where the winding core 20 overlaps the imaginary line V, out of the states where the winding core 20 shown in FIG. 1 is rotating in the rotation direction R so that the electrode plate 5 is wound around it.

When the winding core 20 overlaps the imaginary line V, as shown in FIG. 6, that part of the electrode plate 5 which has passed between the rollers 41 and 42 is pulled away from the side of the imaginary line V where the winding core 20 is located. Accordingly, an angle p defined by that part of the electrode plate 5 which has not yet passed between the rollers 41 and 42 and that part which has passed through there is an obtuse angle. Thus, the part of the electrode plate 5 having passed between the first and second rollers 41 and 42 is slightly wound around that one of the rollers 41 and 42 which is located on the side opposite to that side of the imaginary line V where the winding core 20 is located. In the present embodiment, the roller on the side opposite to that side of the imaginary line V where the winding core 20 is located is the first roller 41.

As shown in FIG. 1, the feeding device 65 feeds the electrode plate 5 toward the winding core 20 when the electrode plate 5 is to be secured to the winding core 20, as described later. The feeding device 65 does not feed the electrode plate 5 while the electrode plate 5 is being wound around the winding core 20. As an example according to the present embodiment, the feeding device 65 feeds the electrode plate 5 in a direction perpendicular to the vertical direction G.

For example, the feeding device 65 comprises a pair of rollers rotatable therein such that the electrode plate 5 is introduced between these rollers. The electrode plate 5 is delivered as the pair of rollers rotate. The feeding device 65 may be configured to deliver the electrode plate 5 by means of a different structure. When the feeding device 65 is not feeding the electrode plate 5, the rollers are freely rotatable and never hinder the movement of the electrode plate 5 being wound around the winding core 20.

The feeding-device position adjustment device 80 is located below the feeding device 65. The position adjustment device 80 serves to adjust the position of the feeding device 65 in the vertical direction G.

The control unit 70 controls the core drive device 30, holding-device position adjustment device 50, and feeding device 65.

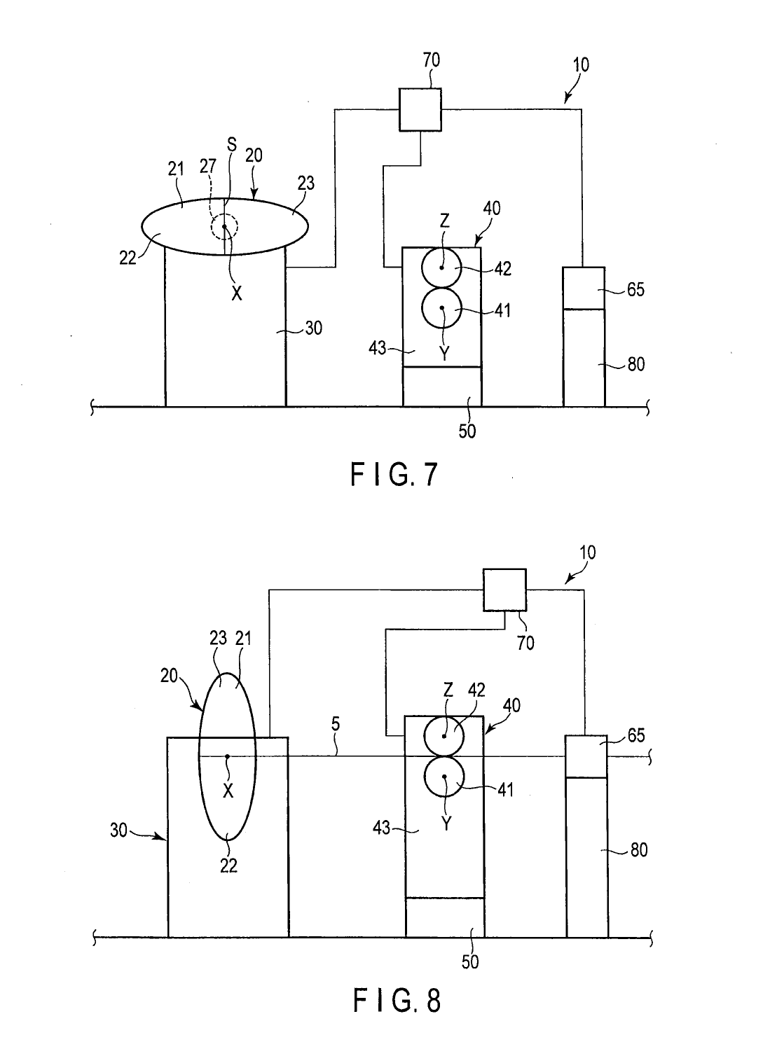

The following is a description of steps of procedure for securing the electrode plate 5 to the winding core 20. FIG. 7 shows a state before the electrode plate 5 is secured to the winding core 20. As shown in FIG. 4, the control unit 70 first controls the core drive device 30 to adjust the posture of the winding core 20 so that the major axis L of the end face 21 extends in the vertical direction G. This is done because the first and second sections 22 and 23 can be separated with the minor axis S therebetween and that the electrode plate 5 is secured to the chuck mechanism 25, which is disposed between the first and second sections 22 and 23 that are spaced apart from each other.

Then, as shown in FIG. 4, the control unit 70 controls the holding-device position adjustment device 50 to align the positions of the first and second rollers 41 and 42 so that the imaginary line V overlaps the chuck mechanism 25. Subsequently, the control unit 70 controls the feeding-device position adjustment device 80 to adjust the position of the feeding device 65 in the vertical direction G depending on the movement of the rollers 41 and 42. Then, the control unit 70 controls the feeding device 65 to feed the electrode plate 5 toward the winding core 20.

The fed electrode plate 5 moves between the first and second rollers 41 and 42 toward the winding core. The electrode plate 5 overlaps the imaginary line V. As the imaginary line V overlaps the chuck mechanism 25, the electrode plate 5 reaches the chuck mechanism 25. When the electrode plate 5 reaches the chuck mechanism 25, it is secured to the chuck mechanism 25. The chuck mechanism 25 may be operated directly by a human operator or its operation may be controlled by the control unit 70.

Then, the control unit 70 controls the fixing mechanism 35 of the core drive device 30 to connect the first and second sections 22 and 23 of the winding core 20 to each other, thereby making the end face 21 elliptical and fixing the winding core 20 in this state. FIG. 8 shows a state where the first and second sections 22 and 23 are connected to each other so that the end face 21 is elliptical. In this state, the electrode plate 5 is held between the first and second sections 22 and 23.

Subsequently, as shown in FIG. 1, the control unit 70 controls the holding-device position adjustment device 50 to move the holding device 40 so that Conditions 1 and 2 are satisfied. Then, the control unit 70 controls the core drive device 30 to rotate the winding core 20 in the rotation direction R. As the winding core 20 is thus rotated, the electrode plate 5 is wound around the winding core 20. The rotation of the winding core 20 is controlled so that the length of the electrode plate 5 wound around the winding core 20 per unit time is constant. This is done because the length of the electrode plate 5 wound around the winding core 20 per unit time becomes irregular due to the elliptical end face 21 if the winding core 20 rotates at a constant speed.

When the winding core 20 is rotating so that the electrode plate 5 is wound around it, in the winding device 10 constructed in this manner, the electrode plate 5 is slightly wound around the first or second roller 41 or 42, as shown in FIGS. 5 and 6. Thereupon, the electrode plate 5 is pulled on either side of the first and second rollers 41 and 42, as indicated by arrows in FIGS. 5 and 6. The resultant of these two tensile forces serves to press the electrode plate 5 against the first or second roller 41 or 42.

When the winding core 20 is rotating so that the electrode plate 5 is wound around it, therefore, the electrode plate 5 is pressed against the first or second roller 41 or 42. As the electrode plate 5 is pressed against the first or second roller 41 or 42, that part of the electrode plate 5 which has passed between the rollers 41 and 42 can be kept from flapping.

As that part of the first roller 41 which is pressed against the second roller 42 is elastically deformed and dented along the outer peripheral portion 42a of the second roller 42, moreover, the electrode plate 5 is held between the first and second rollers 41 and 42 throughout the range 90. Thus, the adhesion of the electrode plate 5 can be improved.

Further, the relative positions of the winding core 20 and holding device 40 can be efficiently adjusted by regulating the position of the holding device 40. The following is a specific description of this point. As described above, the winding core 20 is connected to the core drive device 30. In order to move the core drive device 30, therefore, other devices connected to it should be moved simultaneously. Since the holding device 40 comprises the support block 43 and the first and second rollers 41 and 42 rotatably supported thereon, however, only the holding device 40 should be moved. Thus, the relative positions of the winding core 20 and holding device 40 can be efficiently adjusted by regulating the position of the holding device 40.

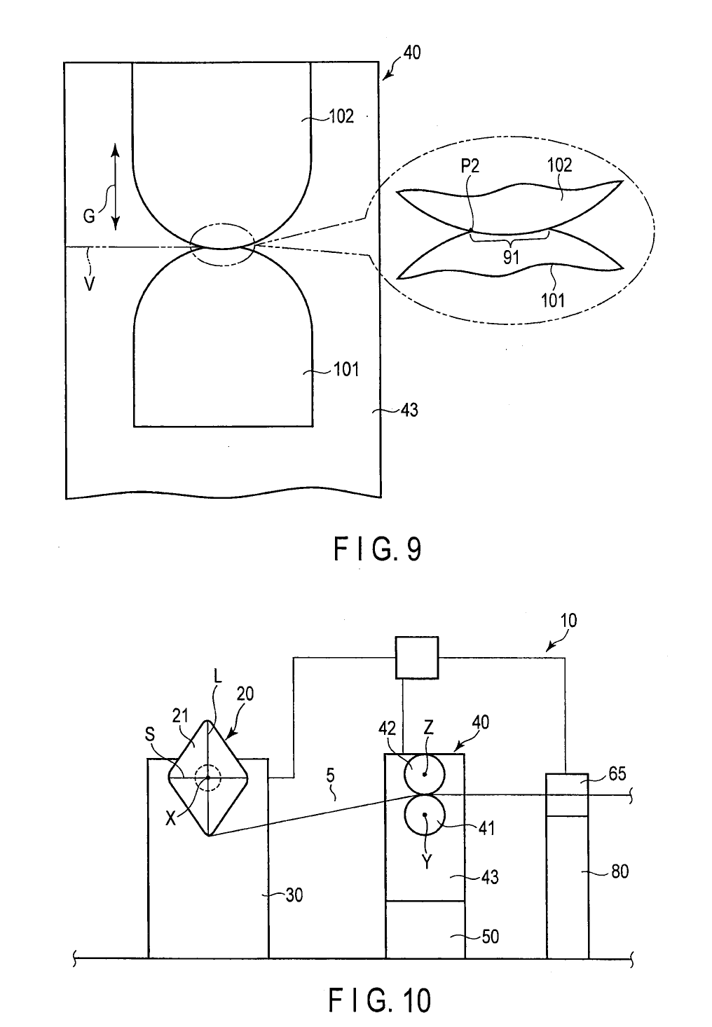

A winding device according to a second embodiment will now be described with reference to FIG. 9. Like reference numbers are used to designate like constituent elements of the first and second embodiments having the same functions, and a repeated description of those elements is omitted. The present embodiment differs from the first embodiment in the structure of a holding device 40. Other structures are the same as those of the first embodiment. The following is a description of the different point.

FIG. 9 shows part of the holding device 40 of the present embodiment. In the present embodiment, first and second pressing sections 101 and 102 are provided in place of the first and second rollers 41 and 42. The pressing sections 101 and 102 have the same shape and size and face each other in a vertical direction G.

The first pressing section 101 is made of the same material as the outer peripheral portion 41a of the first roller 41. The first pressing section 101 is an example of a first holding section. The second pressing section 102 is made of the same material as the outer peripheral portion 42a of the second roller 42. The second pressing section 102 is an example of a second holding section. The first and second pressing sections 101 and 102 are secured to a support block 43 in such a manner that they are pressed against each other in the vertical direction G.

A range of the first and second pressing sections 101 and 102 facing each other is formed to be arc-shaped. When an electrode plate 5 is not held between the pressing sections 101 and 102, therefore, that part of the first pressing section 101 which contacts the second pressing section 102, like the counterpart in the first embodiment, is elastically deformed so that it is dented along the second pressing section 102. In FIG. 9, contact portions of the first and second pressing sections 101 and 102 are shown in an enlarged scale.

The relative positions of a winding core 20 and the holding device 40 where the electrode plate 5 is wound around the winding core 20 are set so as to satisfy the following conditions.

Condition 1: An imaginary line V that passes between the first and second pressing sections 101 and 102 and extends perpendicular to the direction in which the electrode plate 5 is introduced between the pressing sections 101 and 102 and an extending direction D of an axis X of the winding core 20 passes through a position off axis X coincident with the center of rotation of the winding core 20. In the present embodiment, the direction in which the electrode plate 5 is introduced between the first and second pressing sections 101 and 102 is coincident with the vertical direction G in which the pressing sections 101 and 102 are arranged. Thus, according to the present embodiment, the imaginary line V is perpendicular to the vertical direction G and extending direction D. The imaginary line V is indicated by a two-dot chain line in FIG. 9.

Here, the position between the first and second pressing sections 101 and 102 through which the imaginary line V passes is a leading end position P2 in the moving direction of the electrode plate 5, within a range 91 where the pressing sections 101 and 102 contact each other without the electrode plate 5 between them. The contact range 91 and leading end position P2 are shown in FIG. 9.

Condition 2: While the winding core 20 is rotating about axis X so that the electrode plate 5 is wound around it, at least part of the winding core 20 overlaps the imaginary line V.

Conditions 1 and 2 described above are the same as those of the first embodiment provided that the first and second pressing sections 101 and 102 are used in place of the first and second rollers 41 and 42.

The present embodiment provides the same effects as those of the first embodiment.

A winding device according to a third embodiment will now be described with reference to FIG. 10. Like reference numbers are used to designate like constituent elements of the first and third embodiments having the same functions, and a repeated description of those elements is omitted. The present embodiment differs from the first embodiment in the shape of an end face 21 of a winding core 20. Other structures are the same as those of the first embodiment.

FIG. 10 is a schematic view showing a winding device 10 of the present embodiment. As shown in FIG. 10, the end face 21 of the winding core 20 has a rhombic shape. The rhombic shape is an example of the non precise circle shape. The present embodiment provides the same effects as those of the first embodiment. Thus, the shape of the end face 21 of the winding core 20 should only be non precise circle. The winding core 20 of the present embodiment may also be used in the second embodiment.

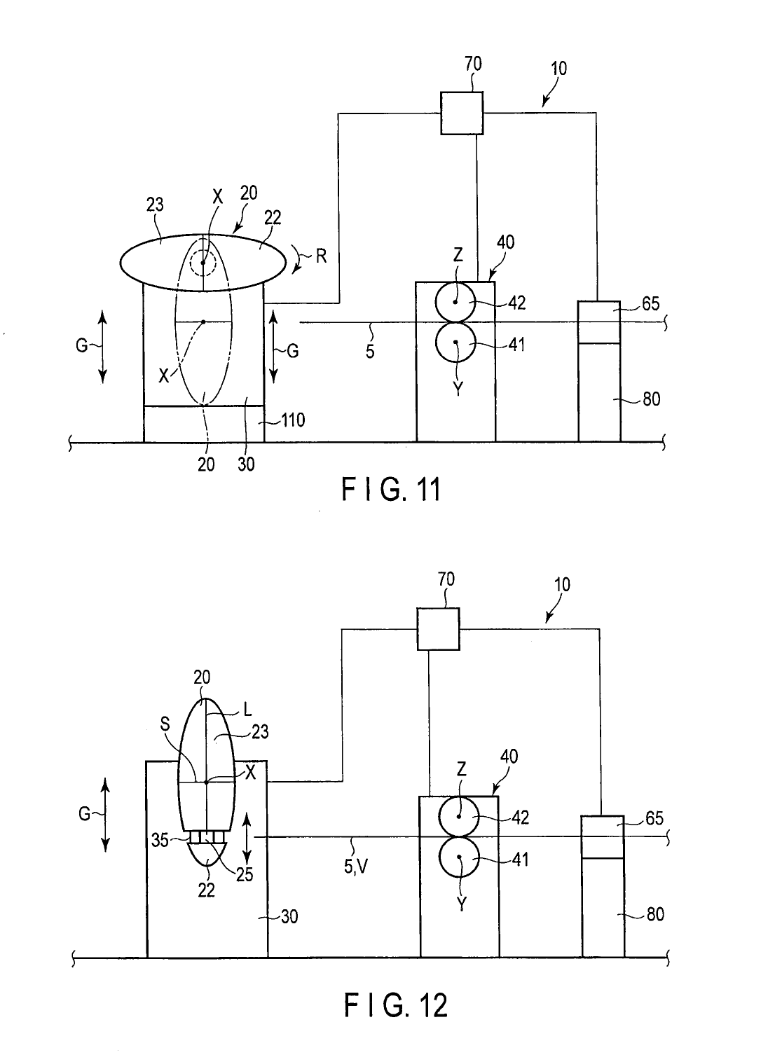

A winding device according to a fourth embodiment will now be described with reference to FIG. 11. Like reference numbers are used to designate like constituent elements of the first and fourth embodiments having the same functions, and a repeated description of those elements is omitted. In the present embodiment, a core-drive-device position adjustment device 110 is provided in place of the holding-device position adjustment device 50. Other structures are the same as those of the first embodiment. The following is a description of the different point.

FIG. 11 is a schematic view showing a winding device 10 of the present embodiment. As shown in FIG. 11, the core-drive-device position adjustment device 110 is located below a core drive device 30. The core-drive-device position adjustment device 110 is an example of the position adjustment device. The position adjustment device 110 serves to adjust the position of the core drive device 30 in a vertical direction G. Thus, the position of a winding core 20 can be adjusted in the vertical direction G.

The core-drive-device position adjustment device 110 may be configured to adjust the position of the core drive device 30 in the vertical direction G by using, for example, a driving force of an electric motor. Alternatively, a pneumatic actuator may be used to adjust the position of the core drive device 30 in the vertical direction G.

In FIG. 11, the winding core 20 moved to a position where an electrode plate 5 is secured to a chuck mechanism 25 by the core-drive-device position adjustment device 110 is indicated by a two-dot chain line. In FIG. 11, the winding core 20 in a position where it rotates in a rotation direction R so that the electrode plate 5 is wound around it is indicated by a full line.

In securing the electrode plate 5 to the chuck mechanism 25 of the winding core 20, according to the present embodiment, the core-drive-device position adjustment device 110 is used to adjust the position of the winding core 20 so that the chuck mechanism 25 overlaps an imaginary line V. Thus, the holding-device position adjustment device 50 is not used in the present embodiment.

The present embodiment provides the same effects as those of the first embodiment. The core-drive-device position adjustment device 110 described in connection with the present embodiment may also be used in the second and third embodiments.

A winding device according to a fifth embodiment will now be described with reference to FIG. 12. Like reference numbers are used to designate like constituent elements of the first and fifth embodiments having the same functions, and a repeated description of those elements is omitted. The present embodiment differs from the first embodiment in the structure of a winding core 20. Other structures are the same as those of the first embodiment. The following is a description of the different point.

FIG. 12 is a schematic view showing a winding device 10 of the present embodiment. In the present embodiment, as shown in FIG. 12, first and second sections 22 and 23 are divided along an imaginary line V in place of the minor axis S. Specifically, as shown in FIG. 12, the positional relationship between the winding core 20 and a holding device 40 is such that an electrode plate 5 is wound around the winding core 20. If the winding core 20 is in such a posture that its major axis L extends parallel to a vertical direction G, the boundary between the first and second sections 22 and 23 overlaps the imaginary line V.

In securing the electrode plate 5 to a chuck mechanism 25 disposed between the first and second sections 22 and 23, therefore, the relative positions of the winding core 20 and holding device 40 need not be adjusted so that the chuck mechanism 25 and imaginary line V overlap each other. Thus, the holding-device position adjustment device 50 is unnecessary in the present embodiment.

According to the present embodiment, based on the effects of the first embodiment, the holding-device position adjustment device 50 need not be used, so that the configuration of the winding device 10 can be simplified.

The winding core 20 of the present embodiment may also be used in the second to fourth embodiments. The core-drive-device position adjustment device 110 is unnecessary if the winding core 20 of the present embodiment is used in the fourth embodiment.

In the first, third, fourth and fifth embodiments, the first and second rollers 41 and 42 as an example of the first and second holding sections contact each other throughout the range 90 when the electrode plate 5 is not held between them. The position between the first and second rollers 41 and 42 through which the imaginary line V passes is assumed to be the leading end position P1 in the moving direction of the electrode plate 5 within the range 90. In the second embodiment, the first and second pressing sections 101 and 102 as an example of the first and second holding sections contact each other throughout the range 91 when the electrode plate 5 is not held between them. The position between the first and second pressing sections 101 and 102 through which the imaginary line V passes is assumed to be the center position P2 in the moving direction of the electrode plate 5 within the range 91.

Thus, the position between the first and second holding sections through which the imaginary line passes is the leading end position in the moving direction of the windable material, such as the electrode plate 5, within a predetermined range if the holding sections contact each other throughout the range, not at a single point, in a cross-section perpendicular to the extending direction of the holding sections when the windable material is not held between them.

If the first and second holding sections contact each other at a single point in the cross-section perpendicular to the extending direction of the holding sections, in contrast, this point is assumed to be the position between the first and second holding sections through which the imaginary line passes.

Although the electrode plate 5 is used as the windable material in the first to fifth embodiments, moreover, it may be replaced with some other material.

According to the first to fifth embodiments, furthermore, the end portion of the winding core 20 along the major axis L overlaps the imaginary line V, and other portions do not. This represents an example where at least part of the winding core overlaps the imaginary line while the winding core is rotating. Alternatively, the imaginary line V may be set so that it always overlaps the winding core.

This invention is not limited directly to the embodiments described herein, and in carrying out the invention, its constituent elements may be embodied in modified forms without departing from the spirit of the invention. Further, various inventions may be made by suitably combining a plurality of constituent elements described in connection with the foregoing embodiments. For example, some of the constituent elements according to the foregoing embodiments may be omitted. Furthermore, constituent elements according to different embodiments may be combined as required.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A winding device comprising:
a winding core configured to rotate so that a windable material is wound therearound and having a non precise circle cross-section perpendicular to a direction in which a center of rotation extends; and
a holding device located upstream relative to the winding core in a moving direction of the windable material and configured to hold the windable material therein, the holding device comprising a first holding section and a second holding section configured to hold the windable material therebetween such that an imaginary line which passes between the first and second holding sections and extends perpendicular to a direction in which the windable material is introduced between the first and second holding sections and the extending direction of the center of rotation passes through a position off the center of rotation and that at least part of the winding core overlaps the imaginary line while the winding core is rotating.

2. The winding device of claim 1, comprising a fixing device provided at the winding core and configured to secure the windable material to the winding core and a position adjustment device configured to adjust relative positions of the winding core and the holding device so that the imaginary line passes through the fixing device.

3. The winding device of claim 2, wherein the position adjustment device adjust a position of the holding device.

4. The winding device of claim 1, comprising a fixing device provided at that position in the winding core where the imaginary line passes through and configured to secure the windable material to the winding core.

5. A winding method comprising:
locating relative positions of a winding core and a holding device, which is located upstream relative to the winding core in a moving direction of a windable material and comprising first and second holding sections, such that an imaginary line which passes between the first and second holding sections and extends perpendicular to a direction in which the windable material is introduced between the first and second holding sections and the extending direction of a center of rotation of the winding core passes through a fixing device disposed in the winding core and configured to secure the windable material to the winding core;
passing the windable material between the first and second holding sections;
securing the windable material passed between the first and second holding sections to the fixing device of the winding core;
locating the relative positions of the winding core and the holding device so that the imaginary line passes through a position off the center of rotation of the winding core and that at least part of the winding core overlaps the imaginary line while the winding core is rotating; and
winding the windable material around the winding core by rotating the winding core.
